(19) United States
(12) Patent Application Publication
(10) Pub. No.: US 2012/0319867 A1
(43) Pub. Date: Dec. 20, 2012

(54) METHODS AND APPARATUS FOR TRAFFIC SIGNAL TIMING

(76) Inventor: Robert L. Gordon, Plainview, NY (US)

(21) Appl. No.: 13/494,600

(22) Filed: Jun. 12, 2012

Related U.S. Application Data
(60) Provisional application No. 61/496,769, filed on Jun. 14, 2011.

(51) Int. Cl. G08G 1/07

(52) U.S. Cl. 340/913

(57) ABSTRACT

The system of the invention analyzes 24-hour volume and occupancy data from traffic system detectors for intervals of fifteen minutes. Alternatively ATR (automatic traffic recorder) traffic count data may be used. However, there is a lesser ability to plan for congestion conditions if ATR data is used. The system utilizes three modules, referred to as MAKETIME™, PLANEED™, and SIGCOMP™. The results of processing are three written reports, which are used to develop the most appropriate number of signal timing plans and their schedules for timing traffic signals.

### CROSS-REFERENCE TO RELATED APPLICATIONS

This application claims benefits from U.S. Provisional Patent Application No. 61/496,769, filed Jun. 14, 2011, the contents of which are hereby incorporated herein by reference.

### BACKGROUND OF THE INVENTION

1. Field of the Invention

This invention relates broadly to methods and apparatus for processing traffic congestion data. More particularly, this invention relates to methods and apparatus for processing traffic volume and occupancy data and developing time-of-day schedules for adjusting the timing of traffic signals based on an analysis of the collected data.

2. State of the Art

While the development of traffic signal timing plans for pre-timed coordinated traffic signals is supported by a number of signal timing programs, there are currently no analytical processes to determine the number of timing plans to use and the appropriate time periods for their use. An example of current practice is described by Koonce, P. et. al., “Traffic Signal Timing Manual”, Kittelson & Associates, Inc., FHWA Report FHWA-HOP-08-024, June, 2008, (hereinafter “TSTM”), the contents of which are hereby incorporated herein by reference.

“The purpose of the [TSTM] is to provide direction and guidance to managers, supervisors, and practitioners based on sound practice to proactively and comprehensively improve signal timing. The outcome of properly training staff and proactively operating and maintaining traffic signals is signal timing that reduces congestion and fuel consumption ultimately improving our quality of life and the air we breathe.

“[The] manual provides an easy-to-use concise, practical and modular guide on signal timing. The elements of signal timing from policy and funding considerations to timing plan development, assessment, and maintenance are covered in the manual. The manual is the culmination of research into practices across North America and serves as a reference for a range of practitioners, from those involved in the day to day management, operation and maintenance of traffic signals to those that plan, design, operate and maintain these systems.” from the Foreword of the TSTM.

According to the TSTM, data from two count locations (such as northbound and southbound) on an artery are collected over time (e.g. over the course of 24 hours) and time schedules for each timing plan to be employed are then manually established by a traffic engineer. This is illustrated diagrammatically in prior art FIG. 1 where data points marked with diamonds are northbound vehicles; data points marked with squares are southbound vehicles; and data points marked with triangles are total traffic volume. The solid rectilinear line in FIG. 1 is a plot of cycle length over time. Together, these time charts can be used to determine the number of timing plans needed for a single traffic signal or for a network of traffic signals and for the schedule for these timing plans. The vertical lines in FIG. 1 define the schedules for four daily timing plans and one late evening timing plan.

The approach may suffer from the following deficiencies: (1) Since the approach is semi-quantitative and does not include a broad computational methodology, it is difficult to perform this inspection for more than a very few approaches. Such a limited sample may be too small to obtain a meaningful picture for the entire section of coordinated traffic signals. (2) Because the approach is not based on quantitative principles, it may result in inferior estimates for the timing plan boundaries. (3) Generally only volume data is conventionally used. While this is satisfactory for low volume to capacity (V/C) ratio traffic signal sections, as volume approaches capacity, queuing and congestion begin to increase exponentially. Small changes in demand result in significant changes in congestion. An approach that does not consider a measure of congestion will often not provide a sufficiently sensitive result under these conditions.

### SUMMARY OF THE INVENTION

It is therefore an object of the invention to identify the appropriate number of timing plans. The number should be high enough to capture the distinct differences in traffic characteristics, and low enough so that differences between characteristics are not minor.

It is another object of the invention to define the best time periods for the use of each timing plan on weekdays.

It is a further object of the invention to define the best time periods for Saturday and Sunday operation, and identify the daily timing plans that may be reused for these days.

It is a further object of the invention to identify those timing plans that were prepared at an earlier time and that are still currently valid.

In accord with these objects, which will be discussed in detail below, the system of the invention analyzes 24 hour volume and occupancy data from traffic system detectors for intervals of fifteen minutes. Alternatively ATR (automatic traffic recorder) traffic count data may be used. However, there is a lesser ability to plan for congestion conditions if ATR data is used. The system utilizes three modules, referred to as MAKETIME™, PLANEED™, and SIGCOMP™. MAKETIME™ analyzes the raw data and provides an output of “signatures” which is based on calculations of volume and occupancy during each of the fifteen minute intervals. PLANEED™ takes the output from MAKETIME™, analyzes it and provides an indication of relative differences between adjacent signatures. SIGCOMP™ compares signatures from weekdays with signatures from Saturdays and Sundays to determine the similarity between weekend and weekday signatures. SIGCOMP™ also compares signatures from current data with signatures for data collected in the past to determine the similarity of these signatures. The outputs from these three modules provide much better information, direction and guidance to managers, supervisors, and practitioners than the conventional methods for establishing timing plans for traffic signals.

Additional objects and advantages of the invention will become apparent to those skilled in the art upon reference to the detailed description taken in conjunction with the provided figures.

### BRIEF DESCRIPTION OF THE DRAWINGS

FIG. 1 is a prior art diagram illustrating traffic volume;

FIG. 2 is a diagram illustrating the comparison of signatures for two timing plans to the actual collected data for a 15 minute period;

FIG. 3 is a diagram illustrating the computation of signature error as compared to collected data for a 15 minute period;

FIG. 4 is a flow chart illustrating the functions of the MAKETIME™ module;

FIGS. 5A-5C are collectively an example of a report from the MAKETIME™ module;

FIG. 6 is a graph showing an example of the comparison measure between signatures;

FIG. 7 is a flow chart illustrating the functions of the PLANEED™ module;

FIG. 8 is an example of an output from the PLANEED™ module;

FIG. 9 is a flow chart illustrating the functions of the SIGCOMP™ module;

FIG. 10 is an example of an output from the SIGCOMP™ module; and

FIG. 11 is a high level block diagram of an apparatus for performing the methods of the invention.

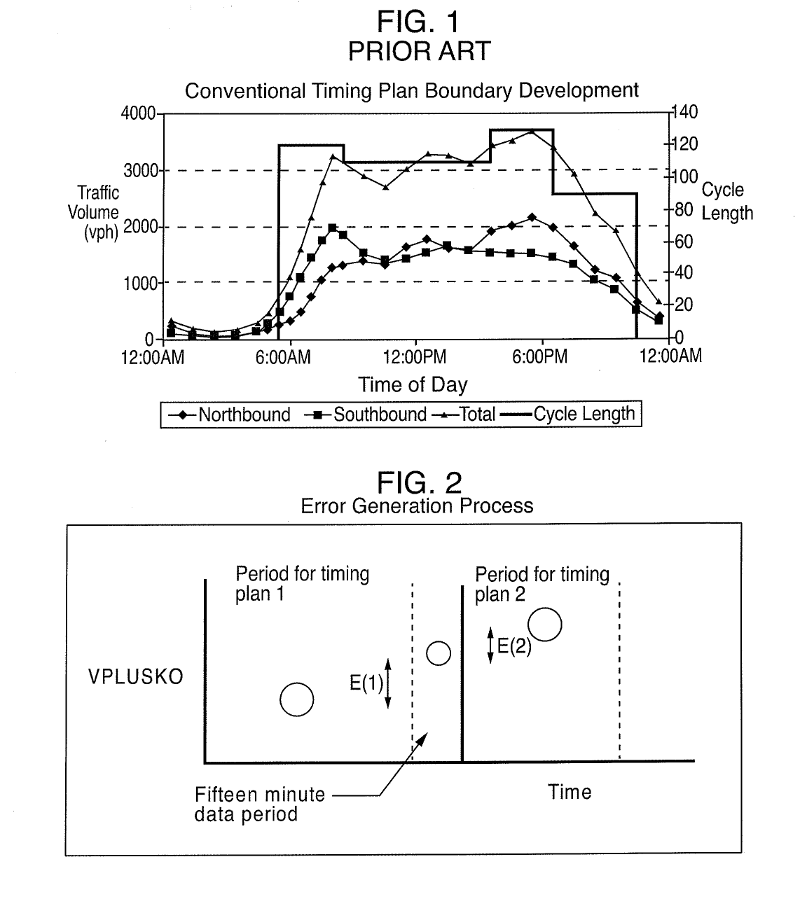

### DETAILED DESCRIPTION

Table 1 illustrates the basic concepts of the three modules in a high level fashion.

TABLE 1

| MODULE | INPUT | PROCESS | OUTPUT |
|---|---|---|---|
| MAKETIME ™ | 15 minute volume and occupancy | Adjust time period boundaries | Printed report for signatures |
| | average data from file developed | for each signature to | and time periods for operation |
| | by traffic signal management | equalize error differences | Signature file (SIGFI) |
| | system or auxiliary program. | between adjacent signatures. | for use by Planeed module |
| PLANEED ™ | SIGFI from | Develops errors between | Printed report showing relative |
| | Maketime module | any two signatures | difference between signatures |
| | | Develops relative difference | and identifies pairs of |
| | | indication between any two | signature periods that may be |
| | | signatures | served by a common timing plan |
| SIGCOMP ™ | SIGFI for weekday from | Develops errors between weekday | Printed report showing |
| | MAKETIME ™ SIGFI for | and Saturday or Sunday signatures | relative difference |
| | Saturday or Sunday or for | Develops relative difference | between signatures |
| | a day from an earlier time | criteria between a weekday | |
| | period from MAKETIME ™ | signature and other signatures | |

The MAKETIME™ module takes the volume and occupancy data from a spreadsheet report. This data is generally collected through traffic system detectors located upstream of an intersection stop line. Volume data, as collected by automatic traffic recorders, may also be employed. It then adjusts time period boundaries for each signature to equalize error differences between the fifteen minute traffic data and the adjacent signatures. A signature (designated as VPLUSKO) is defined below in Equation 1 where volume is in vehicles per hour, K is a constant and occupancy is the percentage of time during the measuring period that the detection zone had a vehicle in it. K is a weighting factor which will be described in more detail below.

VPLUSKO=Volume (veh/hr)+K*Occupancy(%) (Equation 1)

From the foregoing, those skilled in the art will appreciate that VPLUSKO stands for “volume plus weighted occupancy”. The program then analyzes the fifteen minute VPLUSKO data to define the eight or nine daily periods that best differentiate the data. Assuming a particular time period to start with, VPLUSKO is computed for each detector for each fifteen minute interval. These interval values are then averaged over the assumed time period. This averaged set of VPLUSKO values is termed a signature. This computation is also performed for an adjacent assumed time period. A set of VPLUSKO values for a fifteen minute test interval at the boundary between these signature periods is compared with the signatures for each period, and the time boundary is shifted to append the fifteen minute interval to the closer signature. This process is continued until the error between the test interval and each of the signatures adjacent to it is balanced. The signature values are then recomputed to incorporate the fifteen minute period into the new signature boundaries. The MAKETIME™ module outputs a signature file SIGFI which contains the VPLUSKO values for each detector or ATR counter as well as the time periods for which the signature applies.

This concept is illustrated by the following example with reference to FIG. 2. Consider a section with one detector. (It will be appreciated, however, that the one detector example is only provided for illustrative purposes. Several detectors must be employed to achieve a meaningful solution.) Assume that a fifteen minute test data period (shown as the period between the solid and dashed lines) is at or near the time boundary of two timing plan periods, plan 1 and plan 2 (shown as the solid line). The difference in the value of VPLUSKO between this data point and the value for the signatures for each timing plan period is shown in FIG. 2 as E(1) and E(2). In the illustrated example E(1)>E(2). If an earlier 15 minute data period had been selected, E(1) will become smaller because it is closer to the average of volume for all 15 minute data periods in the period for timing plan 1. Similarly E(2) will become larger. The MAKETIME module computes the error values for both of these conditions and appends the fifteen minute period to the signature that provides the smaller error. This process is continued until the boundary no longer shifts.

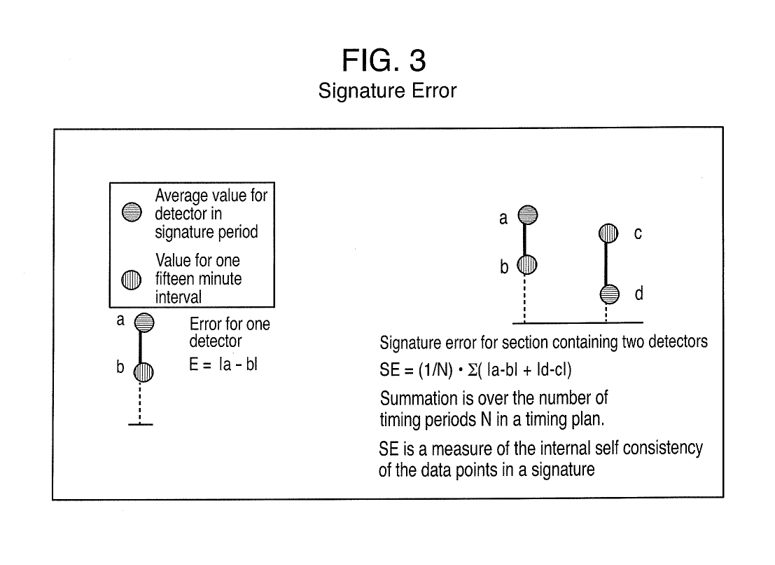

As shown in FIG. 3, error (E) is the absolute value difference between a detector's value for VPLUSKO for a fifteen minute interval, and that detector's value for a signature period (E=|a−b|). FIG. 3 also illustrates the signature error (SE) computation for the detectors in a traffic signal section containing two detectors. This is shown below as Equation 2 where N is the number of timing periods.

$$SE = \frac{\sum ( \vert a - b \vert + \vert d - c \vert )}{N} \qquad ( Equation 2 )$$

Where a=average value of VPLUSKO for Detector 1 for the signature period

b=value of VPLUSKO for Detector 1 for the fifteen minute test interval

c=value of VPLUSKO for Detector 2 for the fifteen minute test interval

d=average value of VPLUSKO for Detector 2 for the signature period

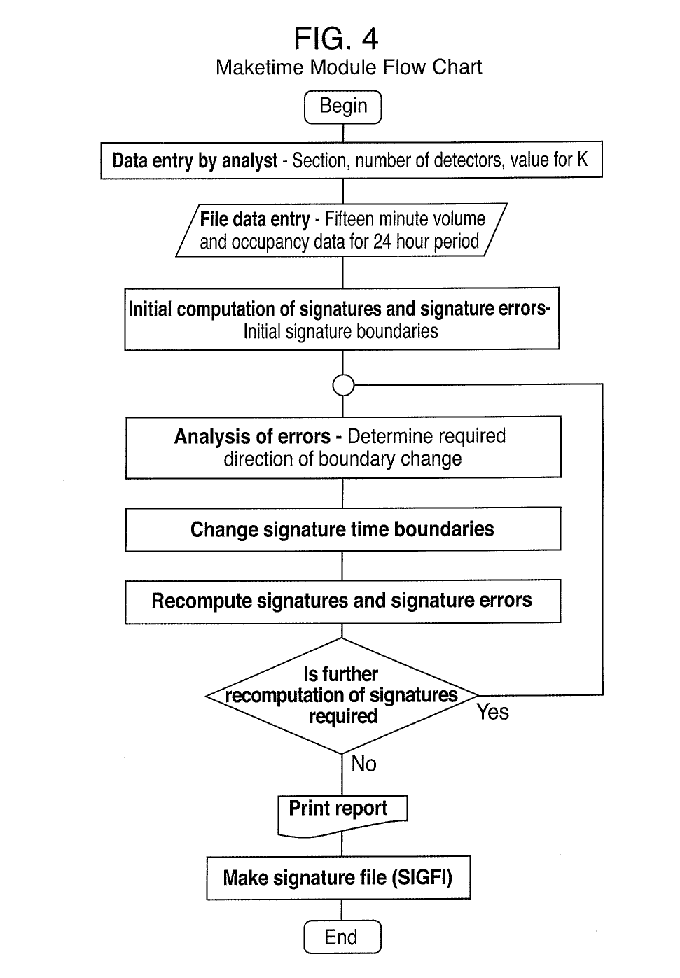

FIG. 4 illustrates the functional operation of the MAKETIME™ module. The module begins with data entry by an analyst. The data includes the identification of the traffic section (group of coordinated signals), the number of detectors or ATR counters in the section, and a value for K. The value for K is determined as follows. If ATR counts are employed, K=0. If traffic detectors that provide volume and occupancy in a lane are employed, the daily fifteen minute occupancy data will be reviewed by the analyst to determine the hour containing the highest average occupancy and its value. Designate this as OCCHI. The value for K is given by

K1=650/OCCHI(%) (Equation 3)

If K1<20 then K=K1 (Equation 4)

If K1≧20 then K=20 (Equation 5)

This is followed by file data entry, i.e. the 15 minute volume and occupancy data collected by detectors for a 24 hour period. Then the initial computation of signatures and signature errors is performed for a set of arbitrary signature boundary periods. Errors are then analyzed to determine the required direction of boundary changes. The signature boundaries are changed accordingly. Signatures and signature errors are then recomputed. Then it is determined whether further re-computation of signatures is required. An example of how this is done is described with reference to the single detector case in FIG. 2. The figure shows that E(1) is greater than E(2). Thus the subsequent test will be performed using a test period that is fifteen minutes earlier. If the test shows E(1) to be greater than E(2), the test period is shifted to an earlier fifteen minute period. If E(2) is now greater than E(1), the test period is no longer shifted, and the boundary between the signatures is established at the location that minimizes the error. When the boundaries for each of the signatures has been established, a report is generated and the signature file (SIGFI) is created. SIGFI contains the signature values and the associated time periods.

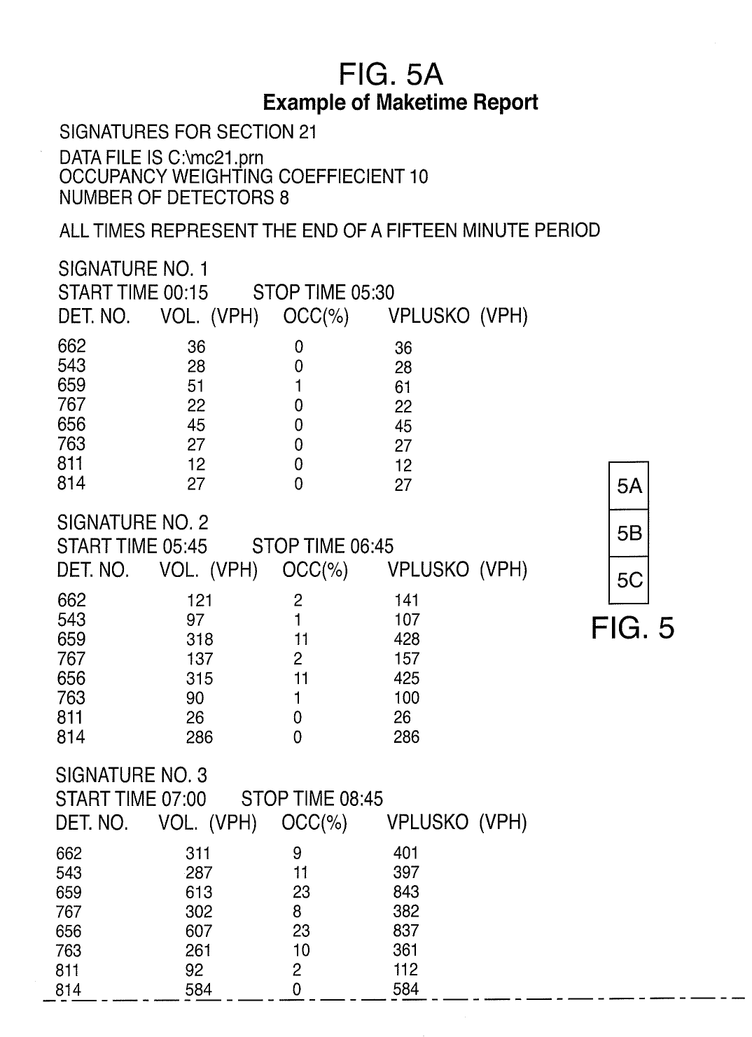

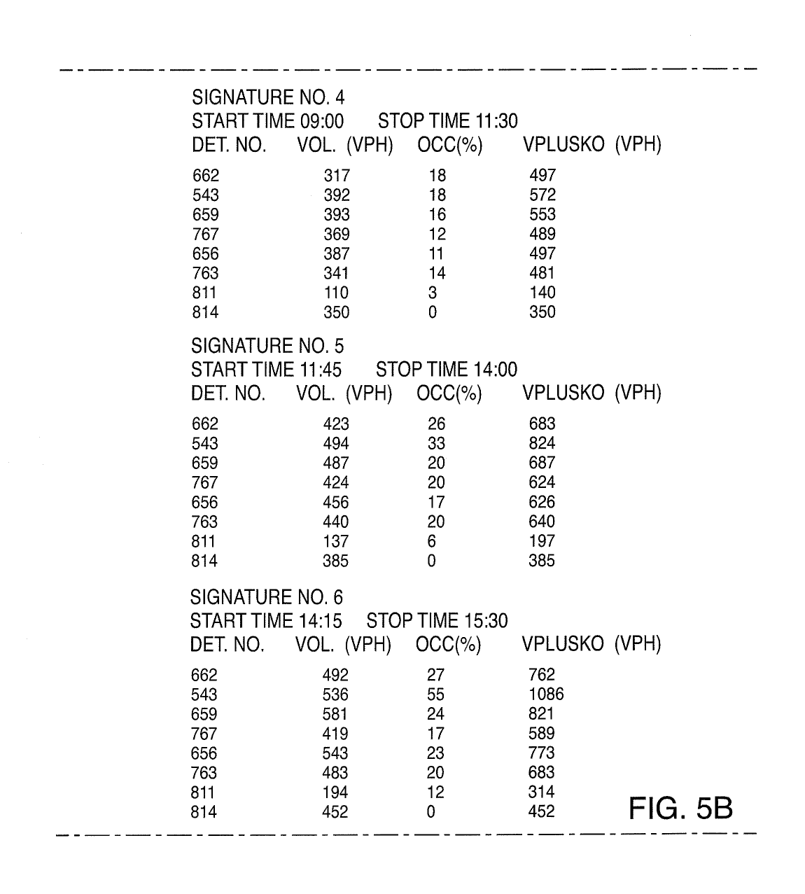

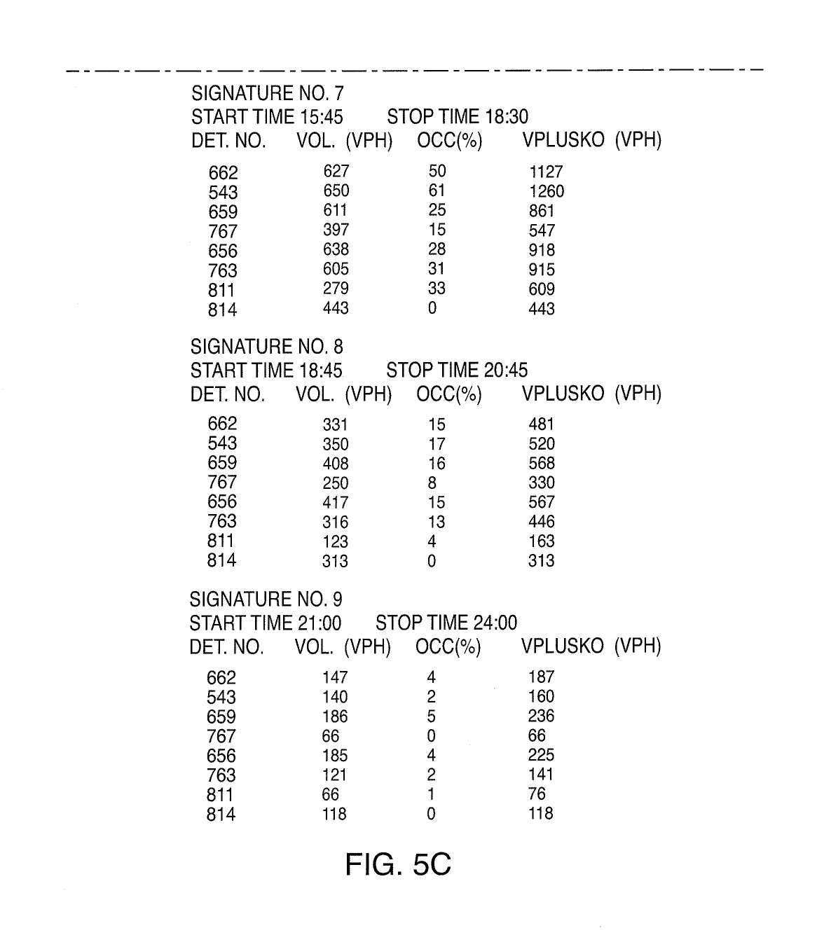

FIGS. 5A-5C are collectively an example of a MAKETIME™ report. In this example, nine signatures are provided. Each signature contains data from eight detectors including volume, occupancy, and VPLUSKO (volume plus weighted occupancy) In the illustrated example, signature 1 is a combination of data taken from the fifteen minute period ending at 00:15 through 05:30; signature 2 is from the fifteen minute period ending at 0:545 through 06:45; signature 3 is from the fifteen minute period ending at 07:00 through 08:45; signature 4 is from the fifteen minute period ending at 09:00 through 11:30; signature 5 is from the fifteen minute period ending at 11:45 through 14:00; signature 6 is from the fifteen minute period ending at 14:15 through 15:30; signature 7 is from the fifteen minute period ending at 15:45 through 18:30; signature 8 is from the fifteen minute period ending at 18:45 through 20:45; and signature 9 is from the fifteen minute period ending at 21:00 through 24:00. Thus, data collected every 15 minutes over the course of 24 hours has been reduced to 9 signatures. Note that the data presented in FIG. 5 is not the timing plan schedule. The timing plan schedule is developed with the assistance of the PLANEED™ and SIGCOMP™ modules as described below.

The PLANEED™ module takes the SIGFI and analyzes the signatures to determine the degree of difference between adjacent signatures. If adjacent signatures are sufficiently similar, a common signal timing plan can serve both signatures. This has the advantages of being less costly to the operating agency to develop and fine tune the timing plan and also results in avoiding traffic flow inefficiencies during transitions between different timing plans. The VPLUSKO values from each signature are compared to the VPLUSKO values in the adjacent signature as illustrated in Equation 6, below where subscript A represents the first signature; B represents the second signature; and I represents the detector.

{DIF}={|VPLUSKO_{AI}−VPLUSKO_{BI}|} (Equation 6)

Those skilled in the art will appreciate that the {DIF} function will result in a one dimensional matrix. In the case of the example illustrated in FIG. 5, the matrix will be 8×1. Equation 7 illustrates the difference between signatures 3 and 4 from FIG. 5.

$$\{ {DIF}_{34} \} = \{ \vert \begin{matrix}\vert 401 - 497 \vert \\ \vert 397 - 572 \vert \\ \vert 843 - 553 \vert \\ \vert 382 - 489 \vert \\ \vert 837 - 497 \vert \\ \vert 361 - 481 \vert \\ \vert 112 - 140 \vert \\ \vert 584 - 350 \vert\end{matrix} \} = \{ \begin{matrix}96 \\ 175 \\ 290 \\ 107 \\ 340 \\ 120 \\ 28 \\ 234\end{matrix} \} \qquad ( Equation 7 )$$

The matrix is then reduced to an average difference between signatures by summing the elements of the matrix and dividing the sum by the number of elements as illustrated in Equation 8 where N is the number of detectors, A is the subscript for the first signature to be tested and B is the subscript for the second signature.

$${SIGDIF}_{AB} = \frac{{\sum }_{1}^{N} {DIF}_{AB}}{N} \qquad ( Equation 8 )$$

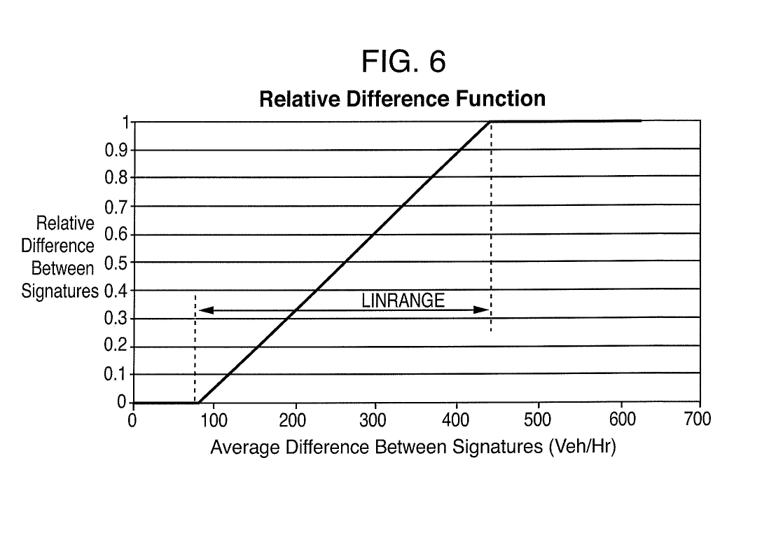

If SIGDIF₃₄ is computed for the values in Equation 7, the result is 174. The SIGDIF between adjacent signatures is then compared with a heuristic function that provides a measure of similarity of the signatures (RELDIF). This is illustrated in FIG. 6. The function was obtained by the analysis of several data sets. The comparison is performed using the following relationships.
LINRANGE is the volume range for the linear portion of the relative difference function shown in FIG. 6. Equations 10 and 11 compute SCALEDIF_{AB} which provides a measure of closeness or relative difference for the two signatures being compared.

If SCALEDIFA_{AB}≧1.0 then SCALEDIF_{AB}=1.0 (Equation 10)

If SCALEDIFA_{AB}<1.0 then SCALEDIF_{AB}=SCALEDIFA_{AB} (Equation 11)

The ability to use the same signal timing plan for periods corresponding to signatures A and B may be determined by comparing SCALEDIF_{AB} with a value (CLTH) selected by the analyst.
The average value of the VPLUSKO elements in each signature is computed as the following summation for all detectors in signature A.

SUMSIG=Σ|VPLUSKO_{AI}|/N (Equation 12)

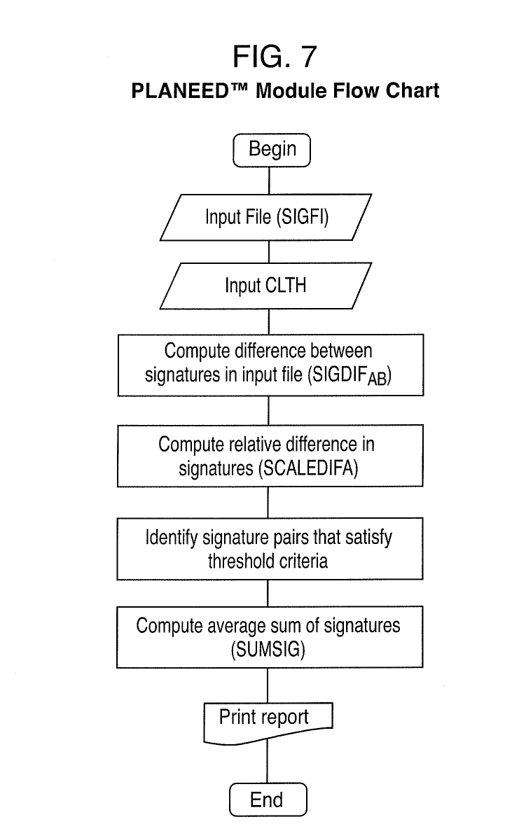

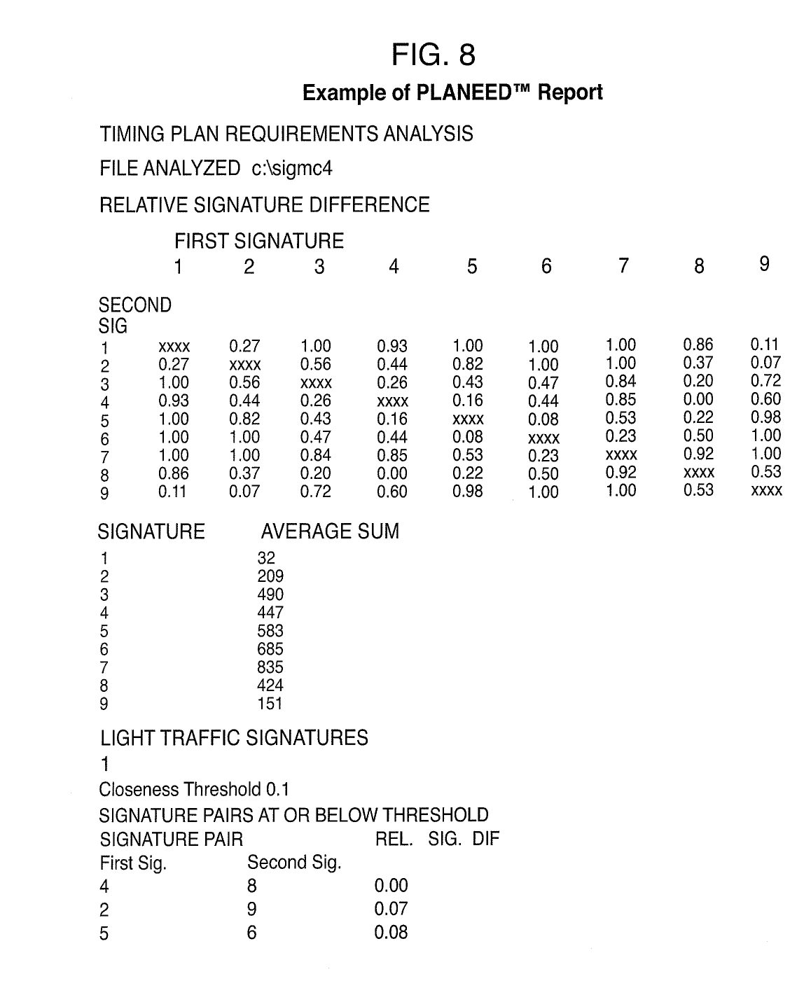

FIG. 7 illustrates the operation of the PLANEED™ module. It begins with the analyst entering the name of the SIGFI to be analyzed and the value of the relative difference (or closeness) threshold (CLTH). It then computes the difference between the signatures (see Equation 4). Then it computes the average of these differences (Equation 8). It then uses the function shown in FIG. 6 in conjunction with Equations 9, 10 and 11 to compute the relative signature difference (SCALEDIF_{AB}). It then computes the average sum of the signatures (SUMSIG). It then compares the relative signature difference with CLTH and identifies the signature pairs that conform to this criteria. It prints a report. An exemplary report is illustrated in FIG. 8.

The objective is to identify signatures that have low relative signature difference coefficients. Coefficients with values of 0-0.15 are to be preferred for the purpose of combining timing plans. Raising this value will lead to further combinations of timing plans. Traffic engineering judgment is required to balance the potential benefits obtained from a larger number of timing plans against the development and maintenance cost of these plans. The example in FIG. 8 shows that three signature pairs satisfy the threshold of 0.10, and each of these pairs may use a common timing plan.

When a single timing plan is to be used for more than one signature period as established by the CLTH coefficient criteria/the average signature sum shown in the FIG. 8 is used to identify the signature period whose traffic data should be used for developing the timing plan for these periods. Timing plans are typically developed by traffic engineers using turning movement counts and timing plan development software. The largest value for the average signature sum for signature periods that will use the same timing plan identifies the period for which turning movement data should be collected.

As an example of the use of the scheduling process using combined timing plans/consider the signature periods in FIG. 5 and a relative signature difference criterion of 0.1. This combination leads to the timing plan schedule of Table 2. Where signatures are combined, the asterisks in Table 2 identify the dominant traffic signature, and the timing plans should be constructed using data obtained for these periods.

TABLE 2

| Signature Period | Start Time | Timing Plan |
|---|---|---|
| 1 | 00:00 | A |
| 2 | 05:30 | B* |
| 3 | 06:45 | C |
| 4 | 08:45 | D* |
| 5 | 11:30 | E |
| 6 | 14:00 | E* |
| 7 | 15:30 | F |
| 8 | 18:30 | D |
| 9 | 20:45 | B |

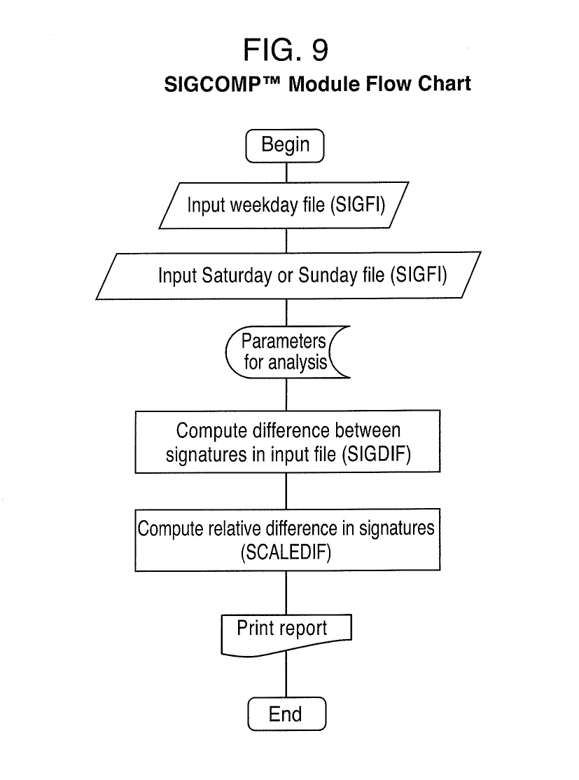

FIG. 9 is a flow chart illustrating the functions of the SIGCOMP™ module. In order to reduce the number of timing plans that must be developed and maintained by agencies, it is desired, when feasible, to use weekday timing plans for Saturday and Sunday or with a signature developed during an earlier time period. The SIGCOMP™ module compares weekday signatures developed by the MAKETIME™ module with Saturday or Sunday signatures or with a signature developed during an earlier time period and developed by the MAKETIME™ module. The comparison process is similar to that of the PLANEED™ module. The mathematical representation of the process is given by Equation 13 where VPKOW represents a weekday signature and VPKOA represents a weekend or an earlier time period signature.

{DIF}={|VPKOW_{Ai}−VPKOA_{Bi}|} (Equation 13)

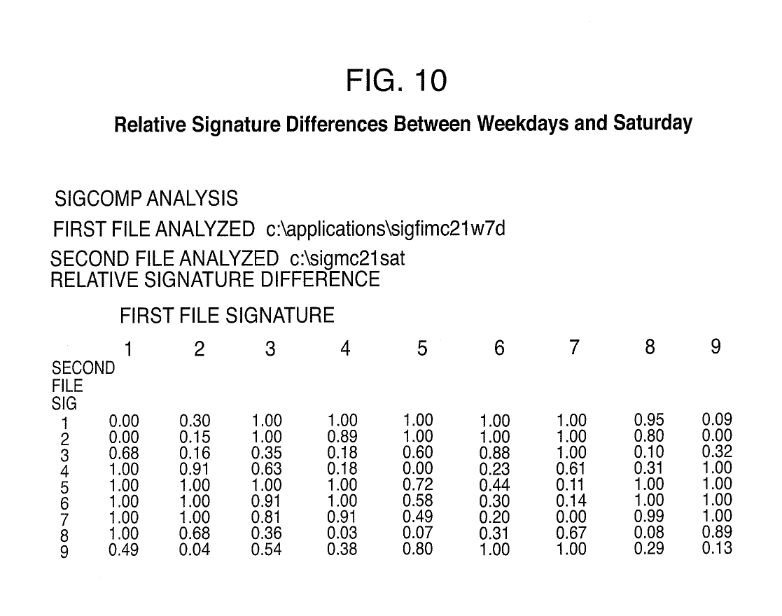

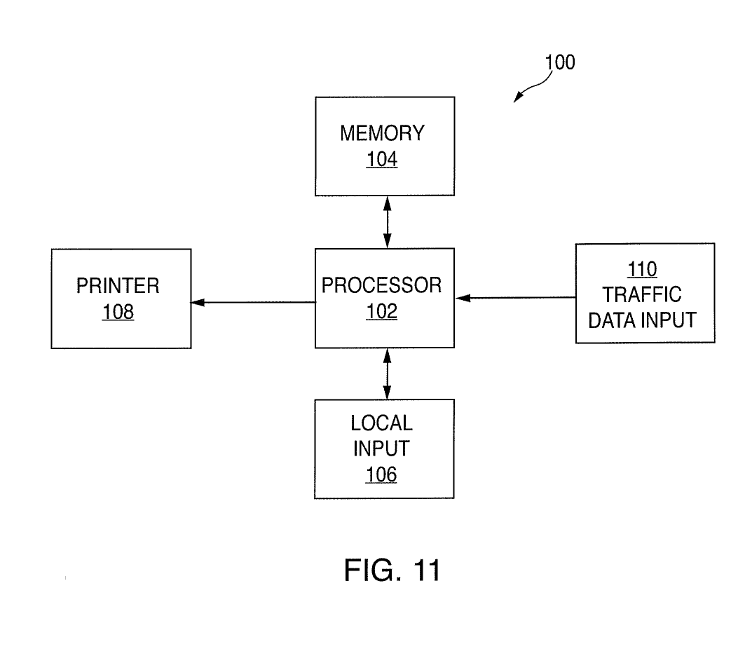

Referring now to FIG. 9, the module begins by loading the weekday SIGFI and either the Saturday, Sunday or earlier time period SIGFI. Parameters are loaded and the differences between signatures are computed to produce SIGDIF. SCALEDIF is then computed and a report is printed. FIG. 10 shows an example of the report where the columns 1-9 represent signatures from the weekday file and the rows represent signatures from the weekend file. Each cell in this 9×9 matrix represents differences between each of the 9 signatures from the weekday file with each of the 9 signatures from the weekend file. A SCALEDIF value of 0.15 or less means that the signatures are sufficiently close to enable the same timing plan to be used for both periods. For example, as shown in FIG. 10, the timing plan for the second signature from the weekday SIGFI can also be used for the period represented by the second signature of the weekend SIGFI. Turning now to FIG. 11, a system 100 for performing the methods of the invention includes a processor 102 with associated memory 104, a local input device 106 such as a keyboard and mouse. 15 minute traffic data 110 is entered into the processor in a spreadsheet format. This data has been previously provided by traffic detectors or automatic traffic counters. The data is processed using the three modules described above which are stored in memory and the results of the processing is stored in the memory and the reports are printed on the printer. The local input device is used to input parameters and constants and to direct the operation of the printer. There have been described and illustrated herein several embodiments of a methods and apparatus for traffic signal timing. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A method for Identifying the most appropriate number of traffic signal timing plans and their schedules, using 24 hour volume and occupancy data from traffic system detectors or automatic traffic recorders collected for intervals of fifteen minutes, said method comprising:
computing signatures and signature errors;
analyzing the errors;
changing signature time boundaries based on the analysis of errors; and
generating a signature file.

2. The method according to claim 1, further comprising:
printing a signature report.

3. The method according to claim 1, further comprising:
inputting the signature file; and
computing the difference between signatures.

4. The method according to claim 3, further comprising:
computing the average sum of the signatures; and
computing the relative difference in the signatures.

5. The method according to claim 4, further comprising:
printing a report of the average sum and the relative differences.

6. The method according to claim 1, wherein:
said using 24 hour volume and occupancy data from traffic system detectors or automatic traffic recorders for intervals of fifteen minutes takes place for a weekday, Saturday, Sunday or for a day in an earlier time period.

7. The method according to claim 6, further comprising:
inputting a second signature file that may be a weekend signature file or a day from an earlier time period;
computing the difference between signatures in the weekday signature file with signatures in the second signature file; and
computing the relative differences in signatures.

8. The method according to claim 7, further comprising:
printing a report of the relative differences in signatures.

9. A system for identifying the most appropriate number of timing plans and their schedules, said system embodied on a computer readable medium coupled to a processor and comprising:
means for inputting 24 hour volume and occupancy data from traffic system detectors or automatic traffic recorders for intervals of fifteen minutes;
means for computing signatures and signature errors;
means for analyzing the errors;
means for changing signature time boundaries based on the analysis of errors; and
means for generating a signature file.

10. The system according to claim 9, further comprising:
means for printing a signature report.

11. The system according to claim 11, further comprising:
means for inputting the signature file; and
and means for computing the difference between signatures.

12. The system according to claim 11, further comprising:
means for computing the average sum of the signatures; and
means for computing the relative difference in the signatures.

13. The system according to claim 12, further comprising:
means for printing a report of the average sum and the relative differences.

14. The system according to claim 9, wherein:
said 24 hour volume and occupancy data from traffic system detectors or automatic traffic recorders for intervals of fifteen minutes takes place for a weekday, Saturday, Sunday or for an earlier time period.

15. The system according to claim 14, further comprising:
means for inputting a weekday signature file and a second file that might be a weekend signature file or a file from an earlier time period;
means for computing the difference between signatures in the weekday signature file with signatures in the second signature file; and
means for computing the relative differences in signatures.

16. The system according to claim 15, further comprising:
means for printing a report of the relative differences in signatures.

17. A computer readable medium containing program instructions for traffic signal timing, wherein execution of the program instructions by one or more processors of a computer system causes the one or more processors to carry out the steps of:
inputting 24 hour volume and occupancy data collected by another system from traffic system detectors or automatic traffic recorders for intervals of fifteen minutes;
computing signatures and signature errors;
analyzing the errors;
changing signature time boundaries based on the analysis of errors; and
generating a signature file.

18. The computer readable medium according to claim 17, wherein execution of the program instructions by one or more processors of a computer system causes the one or more processors to carry out the additional steps of:
printing a signature report.

19. The computer readable medium according to claim 17, wherein execution of the program instructions by one or more processors of a computer system causes the one or more processors to carry out the additional steps of:
inputting the signature file; and
computing the difference between signatures.

20. The computer readable medium according to claim 17, wherein:
said collecting 24 hour volume and occupancy data from traffic system detectors or automatic traffic recorders for intervals of fifteen minutes takes place for an entire week.

21. The computer readable medium according to claim 20, wherein execution of the program instructions by one or more processors of a computer system causes the one or more processors to carry out the additional steps of:
inputting a weekday signature file and a weekend signature file;
computing the difference between signatures in the weekday signature file with signatures in the weekend signature file; and
computing the relative differences in signatures.

22. The computer readable medium according to claim 20, wherein execution of the program instructions by one or more processors of a computer system causes the one or more processors to carry out the additional steps of:
printing a report of the relative differences in signatures.
